(19) United States
(12) Patent Application Publication
(10) Pub. No.: US 2011/0019039 A1
(43) Pub. Date: Jan. 27, 2011

(54) SOLID-STATE IMAGING DEVICE AND CAMERA

(75) Inventors: Makoto IKUMA, Kyoto (JP); Yutaka ABE, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/838,892

(22) Filed: Jul. 19, 2010

(30) Foreign Application Priority Data
Jul. 22, 2009 (JP) 2009-171633

(51) Int. Cl. H04N 9/64

(52) U.S. Cl. 348/246; 348/E09.037; 348/E05.091

(57) ABSTRACT

Specifically, the solid-state imaging device includes: pixels each of which includes an amplifying transistor that amplifies a signal; first column signal lines each of which is connected to one of the columns of the pixels; first load transistors each of which is connected to one of the first column signal lines; a bias circuit which supplies a bias voltage to a gate of each of the first load transistors; first detection units each of which is connected to the one of the first column signal lines; a second detection unit which detects a noise component of each of the rows, the noise component occurring in each of the first column signal lines and resulting from fluctuation in the bias voltage; and a correction unit which corrects, the pixel signal detected by each of the first detection units, using the noise component detected by the second detection unit.

### BACKGROUND OF THE INVENTION

(1) Field of the Invention

The present invention relates to a solid-state imaging device widely used in image input devices especially for video cameras and digital still cameras, and to a camera.

(2) Description of the Related Art

Cell size of photoelectric conversion elements in solid-state imaging devices has been reduced, and mainly high-resolution solid-state imaging devices having more than ten million pixels have been used in market.

Furthermore, in order to realize such high-resolution solid-state imaging devices, various methods for reading out a signal of a CMOS image sensor have been proposed (Patent Reference1: Japanese Unexamined Patent Application Publication No. 2005-323331; Patent Reference 2: Japanese Unexamined Patent Application Publication No. 2006-128704; and Patent Reference 3: Japanese Unexamined Patent Application Publication No. 2000-152098, for example).

In other words, as conventional solid-state imaging devices, column-parallel output CMOS image sensors have been disclosed which select pixels of a row within an imaging region and read out in parallel, through a column signal line, pixel signals each of which is generated by one of the selected pixels, and column A/D image sensors have been suggested in which an AD conversion circuit is provided for each of column signal lines and which convert format of the pixel signals from analog to digital in CMOS image sensors.

Furthermore, FIG. 9 shows the conventional technique disclosed in Patent Reference 3, and the solid-state imaging device disclosed in Patent Reference 3 includes a correction unit which corrects an OB (Optical Black) level so as to reduce noise occurring in an image. The correction unit includes: an OB level calculation unit 191 for a video signal obtained from a light receiving unit; a coefficient calculation unit 192; and a subtracting circuit 193. An OB level difference correction signal is generated by multiplying, in the coefficient calculation unit 192, an output of the OB level calculation unit 191 by a coefficient, and a signal obtained by subtracting, using the subtracting circuit 193, the OB level difference correction signal from the video signal is outputted to an output line 117, the video signal being obtained through an output line 118 from the light receiving unit. Then, the OB level calculation unit 191 ameliorates the OB level by detecting a horizontal OB level for each of horizontal scanning lines and calculating the OB level per horizontal scanning period.

As the solid-state imaging devices have achieved high resolution, it has been desired to reduce noise more than ever. Generally, noise generated from a solid-state imaging device can be broadly divided into horizontal noise and vertical noise, depending on its type.

Most of the vertical noise results from FPN (fixed pattern noise), and correction techniques such as a DSP (digital signal processor) connected at a subsequent stage of the solid-state imaging device make it possible to optimize and remove the most of the vertical noise for each of devices, because columns in which the noise occurs differ for each device.

In contrast, the horizontal noise cannot be corrected for each device, because rows in which the noise occurs and levels are random. For this reason, reduction in an absolute amount of the noise or a correction method has been desired as a solution.

Generally, random noise complies with a normal distribution, and it is difficult to visually recognize the random noise because noise randomly appears on an entire screen. Whereas, the horizontal noise is characterized by being visually recognizable in a row where a level of the horizontal noise is high. Consequently, it is empirically desired that the horizontal noise has a low noise level of approximately one tenth of that of the random noise.

However, the conventional technique shown in FIG. 9 is for correcting the OB level, and it has been difficult to meet horizontal noise standards to be targeted in recent years, by applying the conventional technique as a technique for detecting and correcting horizontal noise for each horizontal scanning line.

Specifically, the calculation of the OB level has been performed for approximately 16 columns in recent years, and an OB level difference of a range from several 100 μV to several mV is corrected. On the other hand, a target level of the horizontal noise is a minute level of approximately several 10 μV that is one tenth to one hundredth of the OB level difference. In order to achieve the horizontal noise having the target level, it is necessary to increase, more than ever, the number of columns in which variation in devices (amplifying transistors, for instance) included in a unit pixel of an OB region or the random noise is averaged, and extract the horizontal noise for each horizontal scanning line. More specifically, although the number of columns of OB regions including pixels has been approximately 16 in recent years, to achieve the above aim, approximately more than 10 times of the number of the columns of the OB regions is required based on the above calculation, and thus a chip area is increased.

### SUMMARY OF THE INVENTION

Consequently, the present invention has been devised to solve the above conventional problems, and has an object to provide a solid-state imaging device capable of reducing visually recognizable horizontal noise and at the same time suppressing an increase in chip area, and a camera.

In order to solve the above problem, a solid-state imaging device according to one aspect of the present invention includes: pixels which are arranged in rows and columns, and each of which includes an amplifying transistor that amplifies a signal; first column signal lines each of which is connected to one of the columns of the pixels, and through each of which the signal amplified by the amplifying transistor is transmitted; first load transistors each of which is connected to one of the first column signal lines; a bias circuit which supplies, through a bias signal line, a bias voltage to a gate of each of the first load transistors; first detection units each of which is connected to the one of the first column signal lines, and detects a pixel signal from the signal transmitted through the one of the first column signal lines; a second detection unit which detects a noise component of each of the rows, the noise component occurring in each of the first column signal lines and resulting from fluctuation in the bias voltage; and a correction unit which corrects, for each of the rows, the pixel signal detected by each of the first detection units, using the noise component detected by the second detection unit.

With this configuration, the noise component of each row resulting from the fluctuation in the bias voltage is detected and the pixel signal is corrected for each row, and thus it is possible to efficiently reduce horizontal noise. In addition, OB regions including photoelectric conversion elements occupying large area are not required, and it is possible to reduce an increase in chip area.

Furthermore, the second detection unit may include: a reference voltage generating unit which is arranged in a row, includes a reference voltage generating transistor, and generates a reference voltage signal; a second column signal line which is connected to the reference voltage generating unit, and through which the reference voltage signal generated by the reference voltage generating unit is transmitted; a second load transistor which is connected to the second column signal line, and has a gate connected to the bias signal line; and a fluctuation detection unit which is connected to the second column signal line, and detects the noise component occurring in the reference voltage signal transmitted through the second column signal line, wherein the correction unit may correct the pixel signal detected by each of the first detection units, using the noise component detected by the fluctuation detection unit included in the second detection unit.

With this configuration, including reference voltage generating units 60 eliminates the need for including the OB regions including the photoelectric conversion elements occupying large area, and it is possible to reduce the horizontal noise with the increase in chip area suppressed. In addition, the first load transistor and the second load transistor are connected to the common bias signal line, and thus it is possible to accurately detect the horizontal noise.

Moreover, the first detection units each may detect the pixel signal by performing correlated double sampling on the signal transmitted through the one of the first column signal lines, and the fluctuation detection unit may detect the noise component by performing the correlated double sampling on the reference voltage signal with same timing as each of the first detection units.

With this configuration, the fluctuation detection unit performs the correlated double sampling with the same timing as the first detection units, and thus it is possible to accurately detect the noise component of each row resulting from the fluctuation in the bias voltage.

Furthermore, the second detection unit may include reference voltage generating units including the reference voltage generating unit, and the correction unit may include: an averaging circuit which calculates an average noise signal by averaging detected noise components; and a subtracting circuit which corrects the pixel signal of each of the columns which is detected for each of the rows, by subtracting the average noise signal from the pixel signal.

Moreover, while pixel signals of each of the rows are detected, the correction unit may hold the average noise signal of a corresponding one of the rows, and the subtracting circuit may correct the pixel signal of each of the columns which is detected for each of the rows, by subtracting the held average noise signal from the pixel signal.

Furthermore, the first detection units each may include a first AD conversion circuit which detects the pixel signal by converting the signal into a first digital signal and performing the correlated double sampling on the first digital signal, the signal being transmitted through the one of the first column signal lines, and the fluctuation detection unit may include a second AD conversion circuit which detects the noise component by converting the reference voltage signal into a second digital signal and performing the correlated double sampling on the second digital signal, the reference voltage signal being transmitted through the second column signal line.

Moreover, the correction unit further may include a signal level limiting circuit which removes, from the noise component, either a component equal to or higher than a first threshold value or a component equal to or lower than a second threshold value, before the averaging circuit calculates average noise signals of each of the rows, and the averaging circuit may calculate the average noise signals of each of the rows, using the noise component from which either the component equal to or higher than the first threshold value or the component equal to or lower than the second threshold value is removed.

With this configuration, it is possible to accurately reduce the horizontal noise with a simple circuit configuration.

Furthermore, a product of a gate width and a gate length of a reference voltage generating transistor may be larger than a product of a gate width and a gate length of the amplifying transistor.

Moreover, the correction unit may multiply a calculated average noise signal by a predetermined coefficient determined according to a ratio of a transconductance value of said amplifying transistor to a transconductance value of the reference voltage generating transistor, and the correction unit may include a subtracting circuit which corrects the pixel signal of each of the columns which is detected for each of the rows, by subtracting the average noise signal multiplied by the predetermined coefficient from the pixel signal.

Furthermore, a ratio of a gate width of a reference voltage generating transistor to a gate length of the same may be equal to a ratio of a gate width of the amplifying transistor to a gate length of the same.

Moreover, a transconductance value of a reference voltage generating transistor may be equal to a transconductance value of said amplifying transistor.

With this configuration, it is possible to reduce 1/f noise depending on a frequency and sensitively detect the noise component of each row resulting from the fluctuation in the bias voltage. Therefore, it is possible to reduce the horizontal noise with the increase in chip area suppressed.

Furthermore, the pixels, the first column signal lines, the first load transistors, the bias circuit, the first detection units, and the second detection unit may be included in a same LSI chip, and the correction unit may be externally attached to the LSI chip.

With this configuration, it is possible to reduce the horizontal noise with the simple circuit configuration.

Moreover, the present invention can be realized not only as the solid-state imaging device but also as a camera including the above configuration.

The present invention produces an advantageous effect of providing the solid-state imaging device capable of reducing the visually recognizable horizontal noise while suppressing the increase in chip area, and a camera.

Further Information about Technical Background to this Application

The disclosure of Japanese Patent Application No. 2009-171633 filed on Jul. 22, 2009 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a schematic line block diagram of a solid-state imaging device according to an embodiment of the present invention;

FIG. 2A is a line block diagram of a pixel according to the embodiment of the present invention;

FIG. 2B is a driving timing diagram of a pixel according to the embodiment of the present invention;

FIG. 3 is a timing diagram at a time of reading out a row Vx showing operations of a first detection unit according to the embodiment of the present invention;

FIG. 4 is a timing diagram showing operations of a second detection unit according to the embodiment of the present invention;

FIG. 5 is a diagram showing operations in one frame performed by the first detection unit according to the embodiment of the present invention;

FIG. 6 is a flowchart showing operations of a correction unit according to the embodiment of the present invention;

FIG. 7 is a circuit diagram concerning a correction unit according to a modification of the present invention;

FIG. 8 is a circuit diagram concerning a correction unit according to another modification of the present invention; and

FIG. 9 is a circuit diagram concerning an OB level correction circuit according to an embodiment of a conventional technique.

### DESCRIPTION OF THE PREFERRED EMBODIMENT(S)

The following describes an embodiment of the present invention with reference to the drawings. Although the present invention will be described using the following embodiment and the appended drawings, it is to be noted that the embodiment and drawings are for exemplary purposes only, and the present invention is not intended to be limited thereto in any way.

(Device Configuration)

First, a configuration of a solid-state imaging device according to the embodiment of the present invention will be described. The present embodiment describes the solid-state imaging device including a reference voltage generating unit 60, a second column signal line 69, a second load transistor 61, and a column AD circuit 65, as a second detection unit which detects, for each of rows, noise components caused by fluctuation in a bias voltage, and a noise correction circuit 70 as a correction unit which corrects, for each row, pixel signals using the noise components detected by the second detection unit. With this, it is possible to reduce visually recognizable horizontal noise and at the same time suppress an increase in chip area.

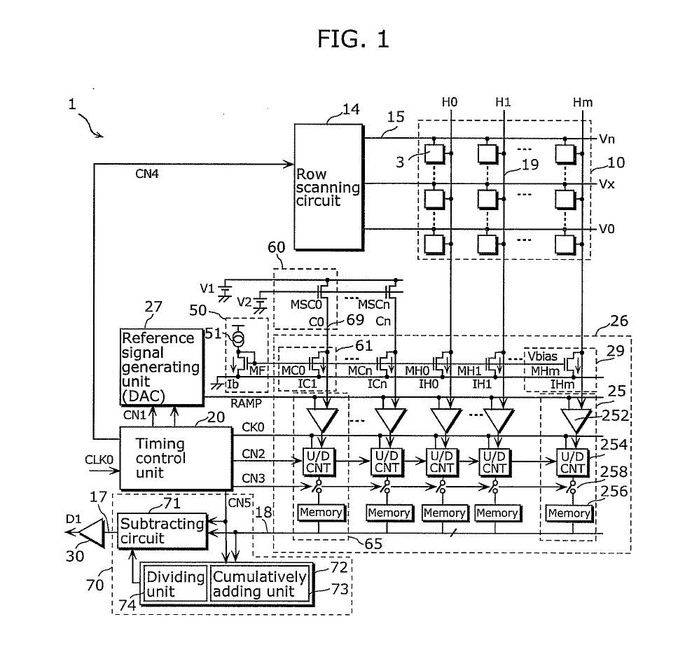

FIG. 1 is a schematic line block diagram of a solid-state imaging device 1 according to the embodiment of the present invention.

As shown in FIG. 1, the solid-state imaging device 1 includes: an imaging region 10 in which unit pixels 3 are arranged in row and column directions; a row scanning circuit 14; a column processing unit 26; reference voltage generating units 60; a bias circuit 50; a reference signal generating unit 27 which generates a reference signal RAMP which temporally changes at a predetermined change rate using a DAC (Digital Analog Converter); a timing control unit 20 which controls various timings; output signal lines 17 and 18; a noise correction circuit 70; and an output circuit 30. The timing control unit 20 generates various internal clocks based on a master clock CLK0 as well as an operation timing control signal for each of blocks.

Furthermore, a first column signal line 19 is provided to each of columns of the unit pixels 3, and the second column signal line 69 is provided to each of columns of the reference voltage generating units 60.

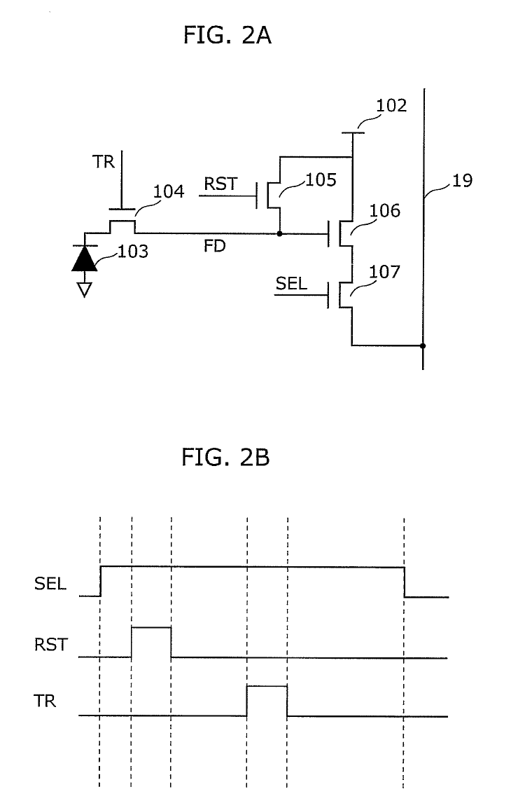

FIG. 2A shows a configuration example of each of the unit pixels 3. As shown in FIG. 2A, the unit pixel 3 includes: a voltage source 102; a photoelectric conversion element 103; a transfer transistor 104 which transfers charge in the photoelectric conversion element 103 to a floating diffusion unit (hereinafter, referred to as a “FD unit”); an amplifying transistor 106 which provides a potential of the FD unit; a reset transistor 105 which resets the potential of the FD unit; and a selection transistor 107 which selects a row.

First, the reset transistor 105 causes the FD unit to be in a reset state according to a reset control signal RST. Next, when light is incident on the photoelectric conversion element 103, charge corresponding to the light is generated. The transfer transistor 104 transfers the charge generated in the photoelectric conversion element 103 to the FD unit according to a transfer control signal TR. Then, the amplifying transistor 106 provides a potential corresponding to the charge in the FD unit to the first column signal line 19 (H0 to Hm) according to a selection control signal SEL for controlling the selection transistor 107. It is to be noted that the row scanning circuit 14 converts the transfer control signal TR, the reset control signal RST, and the selection control signal SEL into optimal voltages according to a control signal CN4 from the timing control unit 20, and provides the voltages to the unit pixel 3 through a row control line 15.

In a pixel readout operation, as shown in FIG. 2B, a column is selected according to a selection control signal SEL, the unit pixel 3 is reset according to a reset control signal RST, and subsequently a signal corresponding to charge generated in the photoelectric conversion element 103 is provided according to a transfer control signal TR.

The reference voltage generating units 60 are arranged in the row direction, and each of the reference voltage generating units 60 includes a reference voltage generating transistor (MSC0 to MSCn) which is a dummy pixel supplying a constant voltage to each reference voltage generating unit 60. The reference voltage generating transistors have drains commonly connected to a constant voltage source V1 and gates commonly connected to a constant voltage source V2. Constant voltages V1 and V2 are supplied to the drains and the gates, respectively.

The column processing unit 26 includes: a first load transistor 29 and a column AD circuit 25 that are provided for each of the first column signal lines 19; and a second load transistor 61 and the column AD circuit 65 that are provided for each of second column signal lines 69. Here, the reference voltage generating unit 60, the second column signal line 69, the second load transistor 61, and the column AD circuit 65 correspond to the second detection unit in the present invention.

Each of the first load transistors 29 (transistors MH0 to MHm) is connected to one of the first column signal lines 19 as a constant current source, and each of the second load transistors 61 (transistors MC0 to MCn) is connected to one of the second column signal lines 69 as a constant current source. The first load transistors 29 and the second load transistors 61 each have a gate connected to the bias circuit 50 through a common bias signal line, and the bias circuit 50 supplies a bias voltage Vbias thereto.

The bias circuit 50 includes a current source 51 and a reference current source transistor MF. The reference current source transistor MF is configured to form a current mirror circuit with each first load transistor 29 and each second load transistor 61.

The column AD circuit 25 includes: a comparator 252 which compares a reference signal RAMP obtained from the reference signal generating unit 27 with a pixel signal obtained from the unit pixel 3 through the first column signal line 19 and the first load transistor 29; a counter 254 which counts an input clock; and a memory 256 which holds a count value obtained by counting performed by the counter 254 from when the reference signal generating unit 27 causes the reference signal to start changing to when the comparator 252 indicates that the pixel signal matches the reference signal. The count value is sequentially transmitted, for each row, from the counter 254 by turning on and off a switch 258, and the count value is held in the memory 256. The count value held in the memory 256 is transmitted to an output signal line 18, and is outputted to the outside via the noise correction circuit 70 and the output circuit 30.

Here, the comparator 252 includes an input capacitance for pixel noise cancelling, and performs CDS (Correlated Double Sampling) in analog domain (hereinafter, referred to as “analog CDS”) at a time of reading out pixel signal, according to a comparator reset signal.

The counter 254 has an up-down counter configuration, and performs a counting operation by switching between an up-count mode and a down-count mode according to a control signal CN2 from the timing control unit 20. With this, it is possible to perform CDS in digital domain (hereinafter, referred to as “digital CDS”) on variation such as variation in clock skew or counter delay of each column which becomes an error in the column AD circuit 25.

As stated above, the column AD circuit 25 performs the to analog CDS and the digital CDS at a time of reading out all the pixels of the row Vx.

It is to be noted that as the column AD circuit 65 has the same configuration as the column AD circuit 25, the description of the configuration of the column AD circuit 65 is omitted. The counter 254 of the column AD circuit 25 and the counter 254 of the column AD circuit 65 correspond to a first AD conversion circuit and a second AD conversion circuit, respectively. A pixel signal and a noise component outputted from each of the counters 254 of the column AD circuits 25 and 65 correspond to a first digital signal and a second digital signal, respectively.

The noise correction circuit 70 includes: an averaging circuit 72 which calculates a noise average signal by averaging, for each row, noise components detected for each row; and a subtracting circuit 71 which subtracts the noise average signal from each of pixel signals detected for each row. The averaging circuit 72 includes: a cumulatively adding unit 72 which cumulatively add the noise components detected for each row; and a dividing unit 74 which divides the cumulatively added noise components by the number of the second column signal lines 69. It is to be noted that the column AD circuit 25, the column AD circuit 65, and the noise correction circuit 70 correspond to a first detection unit, a fluctuation detection unit, and a correction unit in the present invention, respectively.

Here, the following describes operations of the solid-state imaging device according to the present embodiment of the present invention, especially operations in a situation where the column AD circuit 25 performs the CDS on a pixel signal.

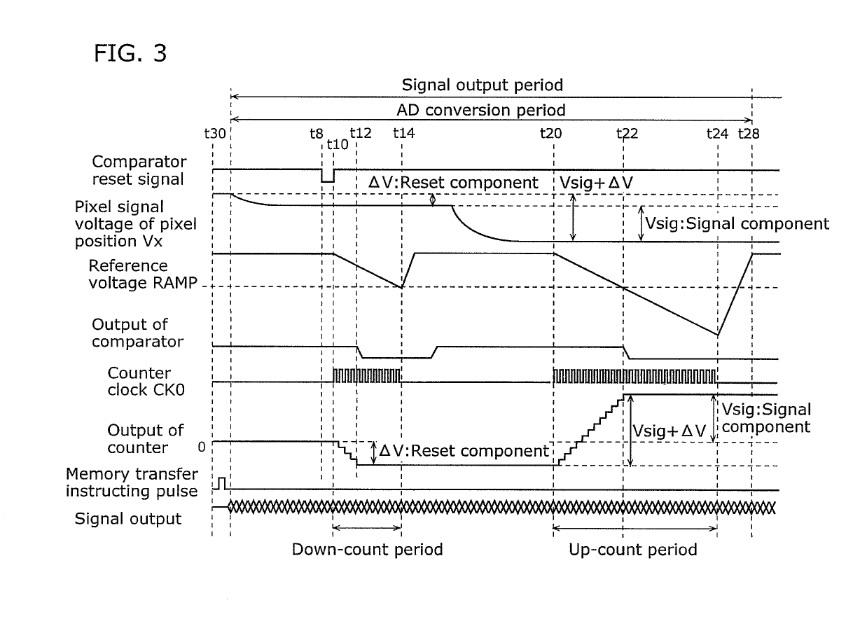

FIG. 3 is a timing diagram showing operations of the first detection unit which detects a pixel signal from the unit pixel 3.

The timing control unit 20 resets a count value of the counter 254 to an initial value “0”, and sets the counter 254 to a down-count mode. Furthermore, the timing control unit 20 causes each of the unit pixels 3 in the row Vx (x=0, 1, 2 . . . , m) to read out a pixel signal having a reset component ΔV. Each of the pixel signals appears in one of the first column signal lines 19. The timing control unit 20 causes the comparator 252 to be in a reset state (time t8 to time t10), and provides control data CN1 to the reference signal generating unit 27 when the pixel signal in the first column signal line 19 becomes stable (time t10). In response, the reference signal generating unit 27 starts temporal change in a reference signal RAMP. Simultaneously, the timing control unit 20 starts input of a clock CK0 to the counter 254 (time t10). In response, the counter 254 starts down count from the initial value “0”.

The reference signal RAMP temporally changes, and matches the reset component ΔV at a certain time (time t12). Here, an output signal of the comparator 252 is inverted, and the counter 254 stops the down count accordingly. The count value at this time corresponds to the reset component ΔV.

When a down-count period elapses (time t14), the timing control unit 20 stops the provision of the control data CN1 to the reference signal generating unit 27, and simultaneously stops the input of the clock CK0 to the counter 254.

Subsequently, the timing control unit 20 sets the counter 254 to the up-count mode, and causes each pixel unit 3 in the row Vx to read out a pixel signal having a signal component Vsig. Apart from setting the counter 254 to the up-count mode, the above method for readout is the same as the readout of reset component ΔV. As stated above, the counter 254 is set to the down-count mode when the reset component ΔV is read out, and is set to the up-count mode when the signal component Vsig is read out, and thus the subtraction is automatically performed within the counter 254, which makes it possible to obtain a count value corresponding to the signal component Vsig.

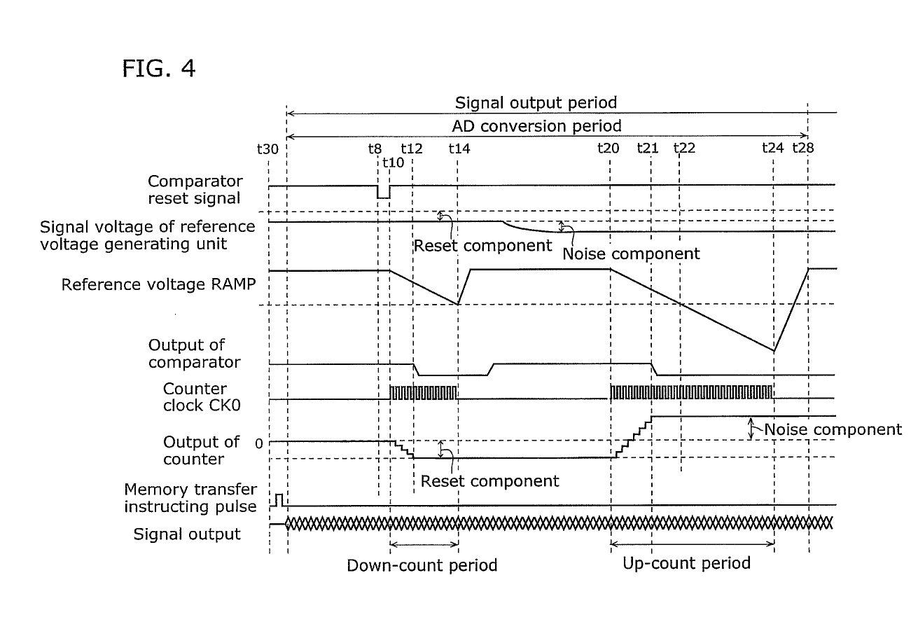

FIG. 4 is a timing diagram showing operations of the column AD circuit 65 which detects noise. The basic operations of the column AD circuit 65 are the same as those of the above-mentioned first detection unit, and the timing control unit 20 controls the column AD circuit 65 concurrently with the control of the column AD circuit 25.

As shown in FIG. 4, before the pixel signal of the unit pixel 3 is detected, the reference voltage generating unit 60 provides a constant voltage, and the unit pixel 3 is reset with the constant voltage provided (time t8 to time t10). When the column AD circuit 25 detects the pixel signal, a noise component is added to the above-mentioned constant voltage, and thus it is possible to obtain a count value corresponding to the noise component by detecting, performed by the column AD circuit 65, the noise component.

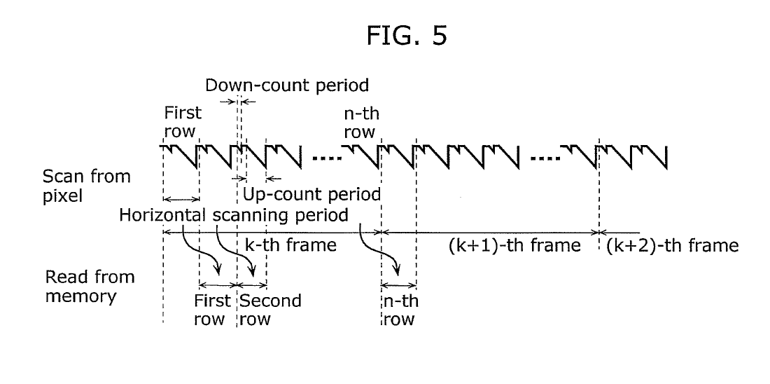

FIG. 5 shows operations in one frame performed by the column AD circuits 25 and 65. In a k-th frame, from readout of the first row to readout of an n-th row, reading out pixel signals and noise components of each of the rows requires a down-count period for the readout of reset component and an up-count period for readout of pixel signal and noise component.

In each of the column AD circuits 25 and 65, the pixel signals and the noise components of the first row are read out and held in the memory 256, and when a first-row horizontal scanning period ends, subsequently the pixel signals and the noise components of the second row are read out. Here, the pixel signal and the noise component of each of the columns of the first row held in the memory 256 are transmitted from the memory 256 to the output signal line 18 during a second-row horizontal scanning period in which the pixel signals and the noise components of the second row are read out.

As stated above, the method for reading out a pixel signal and a noise component includes transmitting, to the output signal line 18, pixel signals and noise components of an (n−1)-th row held in the memory 256 during a horizontal scanning period in which readout of the n-th row is being performed.

Here, an order of reading out the pixel signal and the noise component is as follows: First, a noise component is detected from the reference voltage generating unit 60, signals of the first column H0 to the last column Hm of the imaging region 10 are outputted. This is because when the order is reversed, noise is corrected at the end of each row, which makes signal processing difficult and also delays an output from the output circuit 30 by one row. It is to be noted that concerning a chip layout, the noise correction circuit 70, the reference voltage generating unit 60, and the imaging region 10 are preferably arranged in this order from the output side.

(Mechanism of Horizontal Noise Generation)

The following describes a mechanism of horizontal noise generation that is the problem to be solved by the present invention.

A voltage of each of the photoelectric conversion elements 103 is determined according to brightness of ambient light. For example, each photoelectric conversion element 103 receiving bright light generates a low voltage, whereas the photoelectric conversion element 103 receiving dark light generates a relatively high voltage.

Each of amplifying transistors 106 of pixels of a selected row forms a source-follower structure with one of the first load transistors 29 (transistors MH0 to MHm). Each of analog output voltages of a corresponding one of the first column signal lines 19 is determined by a corresponding one of voltages of FD units of the selected row and a corresponding one of currents IH0 to IHm flowing through the first load transistors 29.

At this time, the bias voltage Vbias is determined by a current Ib flowing through the reference current source transistor MF included in the bias circuit 50.

First, generally, in order to make it less susceptible to influence of power supply voltage fluctuation or temperature fluctuation, the current Ib of the current source 51 is generated from a constant voltage circuit/constant current circuit which is referred to as a band gap reference (BGR) circuit. For this reason, device noise is generated from each of transistor elements and/or resistance elements, and the like.

Furthermore, there is often a distance between the BGR circuit and the reference current source transistor MF in terms of a layout, and the digital noise is added to the current Ib when there is a place where the line through which the current Ib flows and other digital signal lines are intersected run parallel to or intersect with each other.

Moreover, also added is device noise such as thermal noise of the devices of the reference current source transistor MF and 1/f noise depending on a frequency.

As a result, current noise added to the current Ib of the reference current source transistor MF and the device noise of the reference current source transistor MF are added to the bias voltage Vbias of the reference current source transistor MF.

Subsequently, voltage noise added to the bias voltage Vbias of the first load transistor 29 is converted into current noise to be added to the currents IH0 to IHm, and eventually the current noise is converted into voltage noise by the amplifying transistor 106 of the selected row, and the voltage noise is added to the output voltage of the first column signal line 19 (H0 to Hm). Consequently, the noise substantially corresponding to the magnitude of the frequency is added for all the columns of the selected row, which becomes horizontal noise.

It is to be noted that concerning circuit noise, the devise noise such as the thermal noise, which is white noise, and the 1/f noise depending on the frequency is generated from each of the transistor elements and each of the devices such as a resistance element.

The following describes the effect of the digital CDS. The purpose of the digital CDS is to remove, among voltage components added to the bias voltage Vbias of the reference current source transistor MF, a voltage component of a relatively low-frequency region including a DC component.

The first load transistor 29 connected to the first column signal line 19 simultaneously reads out, as the reset component ΔV and a data component (=reset component ΔV+signal component Vsig), signals of the whole pixels of the selected row with the same clock. Then, the column AD circuit 25 calculates a signal component Vsig of the unit pixel 3 using a voltage difference between the reset component ΔV that is stored earlier and the data component (=reset component ΔV+signal component Vsig) that is stored later.

Therefore, noise having a frequency lower than a frequency (time difference in reading out a reset component and a data component (time t22-time t12 in FIG. 3)) in the digital CDS can be removed through the digital CDS, because a noise voltage in the reset component ΔV becomes equal to a noise voltage in the data component (=reset component ΔV+signal component Vsig) that is stored later and the voltage difference in noise is zero.

On the other hand, noise having a relatively high frequency cannot be removed through the digital CDS, because a level differs between time t22 and time t12 and the voltage difference in noise does not become zero, and the noise substantially corresponding the magnitude of the frequency is added for all the columns of the selected row. As a result, the noise becomes visually recognizable as the horizontal noise.

In detail, transfer function H(f) of the digital CDS can be expressed by Equation 1. Here, t indicates a time difference between time t22 and time t12. The absolute value of H(f), |H(f)|̂2, can be expressed by Equation 2. According to Equation 2, a signal or noise having a frequency f lower than a frequency (=1/t) in the digital CDS is |H(f)|̂2≈0, and attenuation is indicated.

H(f)=1−exp(−2πft) (Equation 1)

|H(f)|̂2=2·(1−cos(2πft)) (Equation 2)

As stated above, the digital CDS is effective as a measure against the 1/f noise of the relatively low-frequency region. However, there are realistically some limitations, because it is necessary to increase size of transistors in circuits to reduce an absolute amount and the increase leads to an increase in chip area.

On the other hand, a method for narrowing a signal passband is conceivable as a measure against the white noise having a relatively high-frequency region, because a noise level is determined by a product of a noise density and a signal passband. However, when the signal passband is narrowed excessively, demerits such as delay in transient response and need for newly adding an external capacity occur. Thus, other solutions such as the present invention are desired.

(Procedure for Correcting Horizontal Noise)

The solid-state imaging device 1 according to the present embodiment is characterized by including the reference voltage generating units 60, the second column signal lines 69, the second load transistors 61, the column AD circuits 65, and the noise correction circuit 70, and is capable of correcting and reducing horizontal noise having a relatively high frequency that cannot be removed through the digital CDS. The following describes a procedure for correcting horizontal noise.

First, like the voltage noise added to the bias voltage Vbias of the first load transistor 29, voltage noise added to a bias voltage Vbias of each of the transistors MC0 to MCn included in one of the second load transistors 61 is converted into current noise to be added to the currents IC0 to ICn, subsequently each of the reference voltage generating transistors MSC0 to MSCn included in the reference voltage generating units 60 converts the current noise into voltage noise, and eventually the voltage noise occurs, as an analog voltage, in each of the output signal lines 69 (C0 to Cn) of the corresponding one of the reference voltage generating units 60.

Then, as shown in FIG. 3, the first load transistor 29 reads out, as the reset component ΔV and the data component (=reset component ΔV+signal component Vsig), the signals of the whole pixels of the selected row, and the column AD circuit 25 detects a pixel signal using the voltage difference between the reset component ΔV and the data component (=reset component ΔV+signal component Vsig).

At the same time, as shown in FIG. 4, each second load transistor 61 detects a noise component of the selected row. Here, it is characterized in that a signal to be outputted includes only the noise component, because the constant voltage source V2 always applies a fixed voltage to a gate of each of the reference voltage generating transistors MSC0 to MSCn included in the reference voltage generating units 60 and each of the reference voltage generating transistors is reset with the fixed voltage supplied. Here, the noise component mainly means horizontal noise (or horizontal noise having correlation) having a level equal to that of horizontal noise of the selected row of the imaging region 10 and random noise generated in each of the reference voltage generating transistors MSC0 to MSCn themselves.

For this reason, as shown by Equation 2, assuming that the time difference in reading out the reset component and the data component is t (time t22-time t12), the noise having the frequency lower than the frequency (=1/t) in the digital CDS can be removed through the digital CDS, because the noise voltage in the reset component becomes equal to the noise voltage in the data component that is stored later and the voltage difference in noise is zero.

On the other hand, as the point of the present invention, the noise having the relatively high frequency cannot be removed through the digital CDS, because magnitude differs between time t22 and time 12 and the voltage difference in noise does not become zero, and thus corresponding column AD conversion circuits 25 and 65 can extract such noise.

Moreover, as mentioned above, what needs to be considered here is that the reference voltage generating units 60 detect the horizontal noise having magnitude substantially equal to the magnitude of the frequency for all the columns of the selected row and the random noise generated in each of the reference voltage generating transistors MSC0 to MSCn themselves.

Consequently, in order to calculate horizontal noise for each of horizontal lines, it is necessary to convert, into digital signals, output analog signals of the reference voltage generating transistors MSC0 to MSCn which are detected by the reference voltage generating units 60 and to cause the averaging circuit 72 to cancel and average, for each horizontal line, random noise which differs for each column of the selected row.

Then, subtracting the calculation result of the averaging circuit 72 from each of signals outputted through the output signal line 18 of the imaging region 10 using the subtracting circuit 71 makes it possible to correct and reduce the horizontal noise having the relatively high frequency that cannot be removed through the digital CDS.

In other words, the noise correction in the present invention makes it possible to reduce the horizontal noise, theoretically to zero.

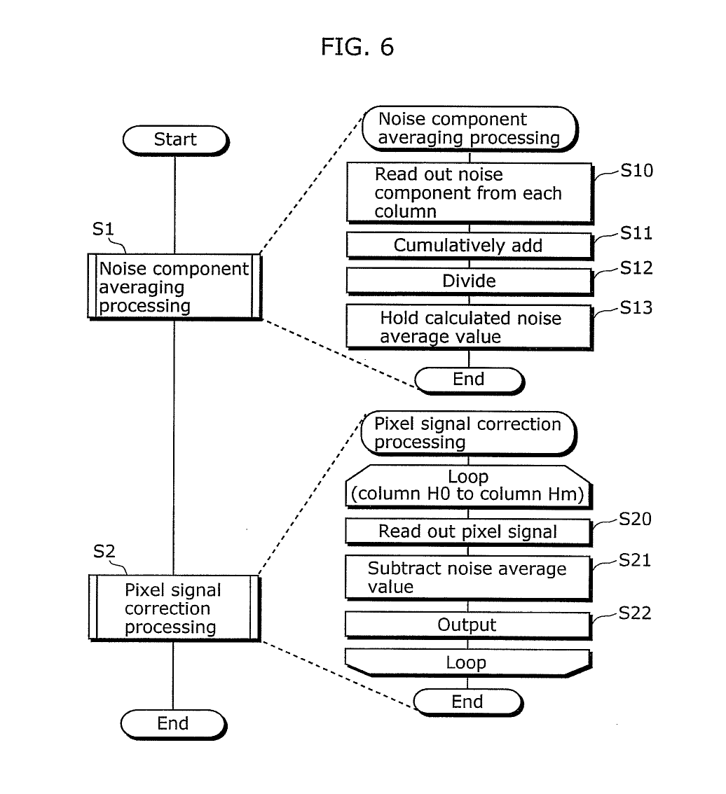

FIG. 6 shows a specific procedure for removing horizontal noise.

First, the averaging circuit 72 and the subtracting circuit 71 are reset by the control signal CN5 from the timing control unit 20. After that, noise component averaging processing is performed for each row (step S1).

To begin with, for one row of the imaging region 10, a noise component of each reference voltage generating unit 60 in one of the columns is sequentially transmitted from a corresponding one of the column AD circuits 65 to the output signal line 18 (step S10), and the noise components are cumulatively added by the cumulatively adding unit 73 (step S11). The cumulatively added noise components are divided by the number of columns of the column AD circuits 65 for which the dividing unit 74 has performed the cumulative adding (step S12), and a noise average signal is calculated for the row. The calculated noise average signal is held while pixel signals of the first column H0 to the last column Hm of the row are transmitted (step S13).

Next, pixel signal correction processing is performed using the noise average signal (step S2). After the noise components of all the columns of the one row are transmitted to the output signal line 18, the pixel signal of each column of the row is sequentially transmitted from the corresponding one of the column AD circuits 25 to the output signal line 18 and corrected. First, the pixel signal of the first column H0 of the row is transmitted to the output signal line 18 (step S20), the noise average signal is subtracted from the pixel signal (step S21) and outputted to the output signal line 17 (step S22) by the subtracting circuit 71. Subsequently, the transmission of the pixel signal and the subtraction are performed for the columns H1 to Hm in the same manner, video data D1 is obtained by correcting all the pixel signals of the one row. Then, the pixel signal correction is performed for each row in the same manner.

It is to be noted that in the case where the number of columns of the reference voltage generating units 60 is n-th power of 2 (2, 4, 8, 16 . . . ), the averaging circuit 72 may be substituted by bit-shifting.

(Gate Length and Width of Reference Voltage Generating Transistor)

The following describes in detail size of gate length and gate width of the reference voltage generating transistors MCS0 to MSCn each included in the one of the reference voltage generating units 60 in the solid-state imaging device according to the present embodiment of the present invention.

A transconductance Gm, which is required for the following description, can be expressed by Equation 3. Here, L is gate length, W is gate width, μ is mobility, Cox is gate oxide film capacitance, and Id is a current flowing through a transistor.

Gm=√(2·μ·Cox·W/L·Id) (Equation 3)

Examples of noise generated in a transistor element include the thermal noise and the 1/f noise. Generally, the 1/f noise converted into a gate input generated in the transistor element can be expressed by Equation 4. Here, a root-mean-square noise voltage Vn̂2 is a function of 1/f with a frequency being f, gate width being W, gate length being L, gate oxide film capacitance being Cox, and a constant being K. Stated differently, the influence of the noise on a low frequency side particularly increases. As is clear from Equation 4, the 1/f noise is inversely proportional to gate area L·W of the transistor element, and thus the 1/f noise is dominant especially in a minute transistor element used in the unit pixel 3 and the influence of the 1/f noise becomes remarkable. It is clear that increasing the gate area L·W reduces the 1/f noise. For instance, it is clear from Equation 4 that increasing the gate area L·W by 100 times reduces the root-mean-square noise voltage Vn̂2 by one tenth.

Vn̂2=K/(Cox·L·W·f) (Equation 4)

Next, first, horizontal noise occurring in an output signal of the amplifying transistor 106 of the unit pixel 3 is calculated. Where a noise level added to the bias voltage Vbias of the first load transistor 29 (each of the transistors MH0 to MHm) is Vg, a transconductance of the first load transistor 29 is Gml, and a transconductance of the amplifying transistor 106 is Gmg, the horizontal noise generated in the amplifying transistor 106 can be expressed by Equation 5.

The horizontal noise generated in the amplifying transistor 106=Vg·Gml/Gmg (Equation 5)

In the meantime, horizontal noise occurring in an output signal of each reference voltage generating unit 60 is calculated. Where a noise level added to the bias voltage Vbias of the second load transistor 61 (each of the transistors MC0 to MCn) is Vg, a transconductance of the second load transistor 61 is Gml, and a transconductance of each of the reference voltage generating transistors MSC0 to MSCn included in the corresponding one of the reference voltage generating units 60 is Gmc, the horizontal noise generated in the reference voltage generating unit 60 can be expressed by Equation 6.

The horizontal noise generated in the reference voltage generating unit 60=Vg·Gml/Gmc (Equation 6)

To put it differently, from Equations 5 and 6, in order to equalize the horizontal noise generated in the amplifying transistor 106 with the horizontal noise generated in the reference voltage generating unit 60, the transconductance Gmg of the amplifying transistor 106 may be equalized with the transconductance Gmc of each of the reference voltage generating transistors MSC0 to MSCn included in the corresponding one of the reference voltage generating units 60. Since the transconductance Gm can be expressed by each of the constants in Equation 3, as the simplest implementation method, for example, by setting the mobility p, the gate oxide film capacitance Cox, and the current Id flowing through the transistor to be equal, clearly, it is only necessary to equalize the W/L ratio of the amplifying transistor 106 of the unit pixel 3 with the W/L ratio of each of the reference voltage generating transistors MSC0 to MSCn.

Here, considered is a hypothetical case where the size of each of the reference voltage generating transistors MSC0 to MSCn included in the corresponding one of the reference voltage generating units 60 is equalized with the size of the amplifying transistor 106 included in the unit pixel 3. Since the gate length L and the gate width W of each of the reference voltage generating transistors MSC0 to MSCn are minute, the 1/f noise expressed by Equation 4 is dominant in the random noise generated in each of the transistors, and a high noise level having some 100 μV is generated. Meanwhile, desired horizontal noise is approximately some 10 μV, and requires a property of approximately one tenth of the random noise.

Next, the random noise detected for each column by a corresponding one of the reference voltage generating transistors MSC0 to MSCn is averaged, and the number of columns for extracting the horizontal noise is calculated. For example, when 100 columns of the reference voltage generating transistors MSC0 to MSCn can be arranged, the gate area L·W of each of the transistors is increased by 100 times, and thus the noise voltage Vn of the 1/f noise which is dominant in the random noise can be reduced by one tenth according to Equation 4. As a result, an average value of the random noise becomes the same level as the horizontal noise, and thus it is clear that the horizontal noise can be accurately extracted and corrected. It is to be noted that in the case of performing the correction in the above manner, the noise correction circuit 70 may multiply the noise average signal by a predetermined coefficient. The predetermined coefficient is determined by a ratio of the transconductance Gmg of the amplifying transistor 106 to the transconductance Gmc of each of the reference voltage generating transistors MSC0 to MSCn according to Equations 5 and 6.

Stated differently, in the present invention, the OB regions including the photoelectric conversion elements 103 occupying large area are not required and the reference voltage generating units 60 substitute for the OB regions, and thus it is clear that the horizontal noise can be reduced with the increase in the chip area suppressed.

The following describes a method for reducing, in the solid-state imaging device 1 according to the present embodiment of the present invention, horizontal noise with an increase in chip area further suppressed.

First, as stated above, the 1/f shown in Equation 4 is dominant in the random noise generated in the amplifying transistor 106. The reason for this is that the 1/f noise is inversely proportional to the gate area L·W of the transistor, and thus the influence of the 1/f noise becomes remarkable especially in a minute transistor used for a pixel. It is clear from Equation 4 that the gate area L·W is increased so as to reduce the 1/f noise.

For this reason, as the point of the present invention, the size of each of the reference voltage generating transistors MSC0 to MSCn included in the corresponding one of the reference voltage generating units 60 is as follows.

First, the horizontal noise can be extracted by equalizing the transconductance Gmc of each of the reference voltage generating transistors MSC0 to MSCn with the transconductance Gmg of the amplifying transistor 106. In brief, the W/L ratios may be equalized so that Gmc and Gmg are equalized.

At the same time, increasing the gate area L·W of a transistor element of each of the reference voltage generating transistors MSC0 to MSCn reduces the 1/f noise, and thus decreases the number of columns of the reference voltage generating units 60.

Here, unlike the unit pixel 3, the reference voltage generating unit 60 does not need to include the photoelectric conversion element 103 occupying large area. Consequently, the area occupied by the photoelectric conversion element 103 can be used.

For instance, increasing the gate length L and the gate width W of each of the reference voltage generating transistors MSC0 to MSCn by 4 times with reference to the amplifying transistor 106 of the unit pixel 3 equalizes the transconductance Gmc with the transconductance Gmg, and further this increases the area by 16 times. As a result, Vn of the 1/f noise is reduced to 1/√16=¼ according to Equation 4.

As stated above, although the reference voltage generating unit 60 is necessary for each of 100 columns when the size of the amplifying transistor 106 of the unit pixel 3 is equal to that of each of the reference voltage generating transistors MSC0 to MSCn, the average value of the random noise becomes the same level as the horizontal noise when 100 columns·¼=25 columns is made possible by the configuration according to the present invention, and thus the horizontal noise can be accurately extracted and corrected.

Moreover, as stated above, equalizing the transconductance Gmg of the amplifying transistor 106 included in the unit pixel 3 with the transconductance Gmc of each of the reference voltage generating transistors MSC0 to MSCn included in the corresponding one of the reference voltage generating units 60 allows the horizontal noise of the same level to be detected. The simplest method is equalizing the W/L ratio of the amplifying transistor 106 of the pixel with the W/L ratio of each of the reference voltage generating transistors MSC0 to MSCn. Here, when it is assumed that Gmg and Gmc are different values, the horizontal noise can be corrected by multiplying a correction value outputted by the averaging circuit 72 with a coefficient.

Specifically, for example, when it is set that Gmg/Gmc=2, a detection value of the horizontal noise of the reference voltage generating unit 60 is twice as high as that of the horizontal noise of the amplifying transistor 106 included in the unit pixel 3, according to Equations 5 and 6. In this case, the horizontal noise can be corrected by multiplying the correction value outputted by the averaging circuit 72 with the coefficient (½).

As described above, the reference voltage generating units 60 make it possible to reduce the horizontal noise without drastically increasing the chip area and the power consumption.

(Modification 1)

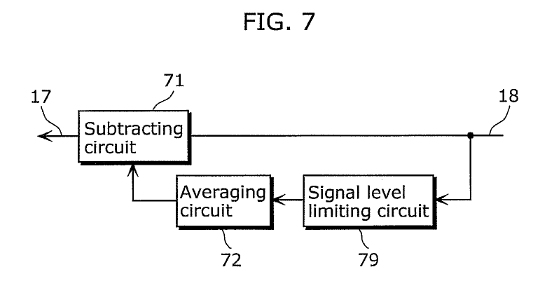

In the solid-state imaging device 1 according to the present embodiment, as shown in FIG. 7, the noise correction circuit 70 may be configured to include, prior to the averaging circuit 72, a signal level limiting circuit 79 which removes a signal having a value equal to or higher than a fixed value (first threshold value) or equal to or lower than a fixed value (second threshold value). This is because there is a case where each of the reference voltage generating transistors MSC0 to MSCn included in the one of the reference voltage generating units 60 has a defect when each of the transistors is small in area or there is a possibility that the frequency of RTS (Random Telegraph Signal) noise, which is digital noise, being generated is increased and noise components resulting from the fluctuation in a bias voltage cannot be accurately averaged.

With the above configuration, even when each of the reference voltage generating transistors MSC0 to MSCn is small in area, noise average signals can be accurately averaged.

(Modification 2)

In the solid-state imaging device 1 according to the present embodiment, the imaging region 10 may further include OB regions each of which detects an OB level and an OB correction circuit 90 which corrects a pixel signal using the OB level.

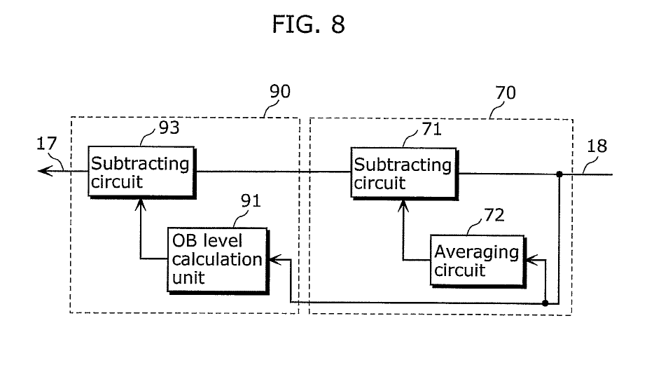

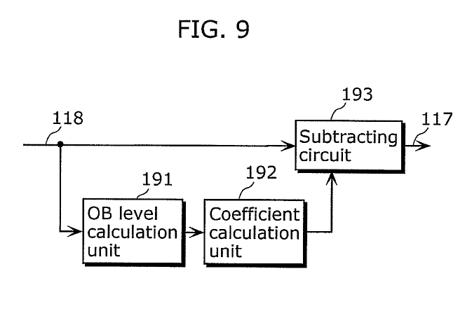

As shown in FIG. 8, the OB correction circuit 90 includes an OB level calculation unit 91 and a subtracting circuit 93. The OB correction circuit 90 performs correction by causing the OB level calculation unit 91 to calculate an OB level for each row, and the subtracting circuit 93 to subtract the OB level from a pixel signal outputted to the output signal line 18.

Further including the OB correction circuit 90 in the above manner makes it possible to reduce the horizontal noise included in the pixel signal more.

It is to be noted that the OB correction circuit 90 may be provided not subsequent to the noise correction circuit 70 but prior to the noise correction circuit 70.

(Summary)

As described above, the solid-state imaging device 1 according to the present invention includes the reference voltage generating units 60, the second column signal lines 69, the second load transistors 61, the column AD circuits 65, and the noise correction circuit 70, and makes it possible to remove the horizontal noise in the high frequency region which cannot be removed through the digital CDS.

Thus, the solid-state imaging device 1 according to the present embodiment of the present invention does not need to include the OB regions including the photoelectric conversion elements 103 occupying large area, and can achieve the reduction in horizontal noise with the increase in chip area suppressed.

It is to be noted that the present invention is not limited to the above embodiment, and various improvements and modifications may be made to the present invention without departing from the gist of the present invention.

For instance, the unit pixels 3, the first column signal lines 19, the first load transistors 29, the bias circuit 50, the column AD circuits 25, the reference voltage generating units 60, the second column signal lines 69, the second load transistors 61, and the column AD circuits 65 may be formed on the same LSI chip. Moreover, the noise correction circuit 70 may be embedded in an LSI chip integrated on the same substrate where the imaging region 10, the column processing unit 26, and the reference voltage generating units 60 are formed, or may be externally attached to the LSI chip.

Furthermore, for example, increasing the gate length L and the gate width W of each of the reference voltage generating transistors MSC0 to MSCn with reference to the amplifying transistor 106 reduces the Vn of the 1/f noise to 1/√64=⅛, and the solid-state imaging device 1 may include 100 columns·⅛≈12 columns of the reference voltage generating units 60, and thus the horizontal noise can be accurately extracted and corrected with the increase in chip area suppressed.

Moreover, concerning the layout of the chip, the column AD conversion circuits 25 corresponding to the unit pixels 3 included in the imaging region 10 may be arranged to be above or below the imaging region 10 depending on whether each of the column AD conversion circuits 25 is in an even column or an odd column. In addition, the noise correction circuit 70 may be independently provided above and below the imaging region 10 in the above configuration. With the above configuration, the effect of reducing the horizontal noise more is exerted. This is because there is a possibility that a correction value of noise differs since GND lines, power lines, and signal lines are not completely line-symmetric to the center of the chip above and below the imaging region 10.

Furthermore, a voltage of the constant voltage source V2 supplied to each of the reference voltage generating units 60 may be, for instance, 0V. With this, a voltage of each of the output signal lines 69 (C0 to Cn) of the reference voltage generating units 60 is 0V, and horizontal noise resulting from noise added to a current Ib of a primary side of one of the first load transistors 29 is not extracted but becomes zero. For this reason, only horizontal noise resulting from noise added to the reference signal RAMP of the reference signal generating unit 27 is extracted, and total horizontal noise is corrected. This is effective in a system where the horizontal noise resulting from the noise added to the reference signal RAMP is dominant in the total horizontal noise.

Moreover, although the imaging region 10 has a one-pixel one-cell structure in the present invention, needless to say, the imaging region may have a multi-pixel one-cell structure.

Furthermore, although the noise correction circuit 70 includes the averaging circuit 72 as a method for calculating a noise correction value in the present invention, needless to say, the noise correction circuit 70 may include a digital filter such as an FIR filter and an IIR filter.

Moreover, although the counters 254 are provided to the column processing unit 26 as an AD conversion structure in the solid-state imaging device 1 according to each of the embodiments of the present invention, the present invention is not limited to the AD conversion structure, because other structures which read out each of reset components and signal components and perform AD conversion produce the same effect as the present invention.

Furthermore, the present invention includes other embodiments realized by combining any constituent elements described in the above embodiment, modifications obtained by making various alterations to the embodiment by a person with an ordinary skill in the art without departing from the gist of the present invention, and various apparatuses including the solid-state imaging device according to the present invention. For example, the present invention includes a camera including the solid-state imaging device according to the present invention.

### INDUSTRIAL APPLICABILITY

As described above, the present invention makes it possible to reduce the visually recognizable horizontal noise with the increase in chip area suppressed, and is useful as the solid-state imaging device of various imaging apparatuses such as digital still cameras, video cameras, and monitoring cameras, and as the camera.

What is claimed is:

1. A solid-state imaging device comprising:
pixels which are arranged in rows and columns, and each of which includes an amplifying transistor that amplifies a signal;
first column signal lines each of which is connected to one of the columns of said pixels, and through each of which the signal amplified by said amplifying transistor is transmitted;
first load transistors each of which is connected to one of said first column signal lines;
a bias circuit which supplies, through a bias signal line, a bias voltage to a gate of each of said first load transistors;
first detection units each of which is connected to the one of said first column signal lines, and each configured to detect a pixel signal from the signal transmitted through the one of said first column signal lines;
a second detection unit configured to detect a noise component of each of the rows, the noise component occurring in each of said first column signal lines and resulting from fluctuation in the bias voltage; and
a correction unit configured to correct, for each of the rows, the pixel signal detected by each of said first detection units, using the noise component detected by said second detection unit.

2. The solid-state imaging device according to claim 1,
wherein said second detection unit includes:
a reference voltage generating unit arranged in a row, including a reference voltage generating transistor, and configured to generate a reference voltage signal;
a second column signal line which is connected to said reference voltage generating unit, and through which the reference voltage signal generated by said reference voltage generating unit is transmitted;
a second load transistor which is connected to said second column signal line, and has a gate connected to the bias signal line; and
a fluctuation detection unit connected to said second column signal line, and configured to detect the noise component occurring in the reference voltage signal transmitted through said second column signal line,
wherein said correction unit is configured to correct the pixel signal detected by each of said first detection units, using the noise component detected by said fluctuation detection unit included in said second detection unit.

3. The solid-state imaging device according to claim 2,
wherein said first detection units each are configured to detect the pixel signal by performing correlated double sampling on the signal transmitted through the one of said first column signal lines, and
said fluctuation detection unit is configured to detect the noise component by performing the correlated double sampling on the reference voltage signal with same timing as each of said first detection units.

4. The solid-state imaging device according to claim 1,
wherein said second detection unit includes reference voltage generating units including said reference voltage generating unit, and
said correction unit includes:
an averaging circuit which calculates an average noise signal by averaging detected noise components; and
a subtracting circuit which corrects the pixel signal of each of the columns which is detected for each of the rows, by subtracting the average noise signal from the pixel signal.

5. The solid-state imaging device according to claim 4,
wherein, while pixel signals of each of the rows are detected, said correction unit is configured to hold the average noise signal of a corresponding one of the rows, and
said subtracting circuit corrects the pixel signal of each of the columns which is detected for each of the rows, by subtracting the held average noise signal from the pixel signal.

6. The solid-state imaging device according to claim 3,
wherein said first detection units each include a first AD conversion circuit which detects the pixel signal by converting the signal into a first digital signal and performing the correlated double sampling on the first digital signal, the signal being transmitted through the one of said first column signal lines, and
said fluctuation detection unit includes a second AD conversion circuit which detects the noise component by converting the reference voltage signal into a second digital signal and performing the correlated double sampling on the second digital signal, the reference voltage signal being transmitted through said second column signal line.

7. The solid-state imaging device according to claim 4,
wherein said correction unit further includes a signal level limiting circuit which removes, from the noise component, either a component equal to or higher than a first threshold value or a component equal to or lower than a second threshold value, before said averaging circuit calculates average noise signals of each of the rows, and
said averaging circuit calculates the average noise signals of each of the rows, using the noise component from which either the component equal to or higher than the first threshold value or the component equal to or lower than the second threshold value is removed.

8. The solid-state imaging device according to claim 1,
wherein a product of a gate width and a gate length of a reference voltage generating transistor is larger than a product of a gate width and a gate length of said amplifying transistor.

9. The solid-state imaging device according to claim 8,
wherein said correction unit is configured to multiply a calculated average noise signal by a predetermined coefficient determined according to a ratio of a transconductance value of said amplifying transistor to a transconductance value of the reference voltage generating transistor, and
said correction unit includes a subtracting circuit which corrects the pixel signal of each of the columns which is detected for each of the rows, by subtracting the average noise signal multiplied by the predetermined coefficient from the pixel signal.

10. The solid-state imaging device according to claim 1,
wherein a ratio of a gate width of a reference voltage generating transistor to a gate length of the same is equal to a ratio of a gate width of said amplifying transistor to a gate length of the same.

11. The solid-state imaging device according to claim 1,
wherein a transconductance value of a reference voltage generating transistor is equal to a transconductance value of said amplifying transistor.

12. The solid-state imaging device according to claim 1,
wherein said pixels, said first column signal lines, said first load transistors, said bias circuit, said first detection units, and said second detection unit are included in a same LSI chip, and
said correction unit is externally attached to the LSI chip.

13. A camera comprising the solid-state imaging device according to claim 1.
